(19) United States
(12) Patent Application Publication
(10) Pub. No.: US 2011/0125398 A1
(43) Pub. Date: May 26, 2011

(54) NAVIGATION APPARATUS, SERVER APPARATUS AND METHOD OF PROVIDING POINT OF INTEREST DATA

(76) Inventor: Tammo Cornelis Bos, Amsterdam (NL)

(21) Appl. No.: 12/736,912

(22) PCT Filed: Oct. 8, 2008
(86) PCT No.: PCT/EP2008/063486

§ 371 Date: Jan. 5, 2011

(51) Int. Cl. G01C 21/36; G06F 15/16

(52) U.S. Cl. 701/204; 701/207; 701/200; 709/219

(57) ABSTRACT

A navigation apparatus includes a communications interface for communicating data via a communications network and a processing resource coupled to the interface and arranged to receive a request for point of interest information, and to communicate via the communications interface a message constituting a point of interest data request for receipt by a remote server. In at least one embodiment, the processing resource is capable of receiving via the communications interface POI data identifying a first POI and a second POI, the POI data being in response to the message and arranged to provide an indication of relative temporal proximity of the first and second POIs. The processing resource is also arranged to respond to the request for POI information by identifying the first POI and the second POI and relative temporal proximity information relating thereto, the relative temporal proximity information being based upon the indication of relative temporal proximity received.

### FIELD OF THE INVENTION

The present invention relates to a navigation apparatus of the type that, for example, is capable of providing point of interest information upon request. The present invention also relates to a server apparatus of the type that, for example, is capable of generating point of interest data in response to a request therefor. The present invention also relates to a method of providing point of interest data, the method being of the type that, for example, provides point of interest data in relation to a location of a navigation apparatus.

### BACKGROUND TO THE INVENTION

Portable computing devices, for example Portable Navigation Devices (PNDs) that include GPS (Global Positioning System) signal reception and processing functionality are well known and are widely employed as in-car or other vehicle navigation systems.

In general terms, a modern PND comprises a processor, memory and map data stored within said memory. The processor and memory cooperate to provide an execution environment in which a software operating system is typically established, and additionally it is commonplace for one or more additional software programs to be provided to enable the functionality of the PND to be controlled, and to provide various other functions.

Typically, these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking), are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the GO 930 Traffic model manufactured and supplied by TomTom International B.V., provide a reliable means for enabling users to navigate from one position to another. Such devices are of great utility when the user is not familiar with the route to the destination to which they are navigating.

As indicated above, one or more POIs can be selected by a user of the PND in respect of a journey to be embarked upon or during a journey. To select a POI during a journey, a user typically negotiates a menu structure of a user interface of the PND in order to select a type of POI desired, for example a supermarket. The application software of the PND then determines, using locally stored data, a number of POIs of the type selected by the user and presents the determined POIs to the user via the user interface. To assist the user, the application software typically orders the POIs identified by distance from a current location of the PND and indicates an associated distance adjacent the POI listed. The user can then select one of the POIs identified by the user interface and the application software. In response to selection of one of the POI, the application software, integrates the POI chosen into a route calculated, for example by recalculating an existing route to take into account the selection made by the user.

On the whole, this technique works quite well and provides satisfactory results for the user. However, distance is the criterion used to order the POIs determined by the application software, in particular respective straight-line distance from the current location of the PND to each POI determined. A disadvantage of this approach is that although a POI may be physically closest to the current location of the PND, the POI may not be temporally closest due to a number of factors, including: prevailing traffic conditions between the current location of the PND and the POI, road closures, detours and other factors which are not taken into account as a result of using distance as a sole criterion for assessing proximity of POIs to the current location of the PND. Indeed, whilst a POI may be physically closest to the current location of the PND, other POIs of the same type may actually be temporally closest to the current location of the POI. If, for example, the POI is a petrol station, the user may wish to reach the POI in a shortest time possible due to shortage of fuel. Hence, it can be seen that the use of distance as the criterion to determine proximity of the POI to the current location of the PND can be misleading in some circumstances. Presently, PNDs use locally stored databases of POI data that simply comprise basic information concerning the POIs stored and associated location information. Using this information, the PND calculates the straight-line distances mentioned above between POIs and the current location of the PND in order to rank the POIs sought by the user.

### SUMMARY OF THE INVENTION

According to a first aspect of the present invention, there is provided a navigation apparatus comprising: a communications interface for communicating data via a communications network; a processing resource coupled to the communications interface, the processing resource being arranged, when in use, to receive a request for point of interest information, and to communicate via the communications interface a message constituting a point of interest data request for receipt by a remote server; wherein the processing resource is capable of receiving via the communications interface point of interest data identifying a first point of interest and a second point of interest, the point of interest data being in response to the message and arranged to provide an indication of relative temporal proximity of the first and second points of interest; and the processing resource is arranged to respond to the request for point of interest information by identifying the first point of interest and the second point of interest and relative temporal proximity information relating thereto, the relative temporal proximity information being based upon the indication of relative temporal proximity received.

The processing resource may be arranged to extract from the point of interest data information identifying the first point of interest and the second point of interest and the relative proximity information.

The indication of the relative temporal proximity may be an indication of calculated relative temporal proximity.

The processing resource may be arranged to determine self-location information and the indication of relative temporal proximity may be with respect to a location associated with the self-location information.

The point of interest data received may be ordered by relative temporal proximity.

The point of interest data may comprise respective temporal data for each of the first and second points of interest.

The indication of relative temporal proximity may be time data. The indication of relative temporal proximity may be time of arrival data. The indication of relative temporal proximity may be journey time data. The indication of relative temporal proximity may be estimated.

The processing resource may be arranged to support a user interface, and to receive the request for point of interest information via the user interface.

According to a second aspect of the present invention, there is provided a server apparatus comprising: a communications interface for communicating data via a communications network; and a processing resource coupled to the communications interface, the processing resource being arranged, when in use, to receive via the communications interface a message constituting a point of interest data request; wherein the processing resource is arranged to generate point of interest data in response to the received message and communicate via the communications interface the point of interest data for receipt by a navigation apparatus, the point of interest data identifying a first point of interest and a second point of interest; and the point of interest data is arranged to provide an indication of relative temporal proximity of the first and second points of interest.

The indication of relative temporal proximity may be an indication of calculated relative temporal proximity.

The processing resource may be arranged to access a database of points of interest data and determine the first and second points of interest from the database of points of interest data.

The processing resource may be arranged to receive location information and to calculate a first optimum route from a location identified by the location information received to the first point of interest and an associated first temporal proximity of the location identified to the first point of interest.

The first optimum route may be a first temporally shortest route.

The location information may result from a self-location determination of a navigation apparatus.

The processing resource may be arranged to receive location information and to calculate a second optimum route from a location identified by the location information received to the second point of interest and an associated second temporal proximity of the location identified to the second point of interest.

The second optimum route may be a second temporally shortest route.

The processing resource may be arranged to access traffic data and to use the traffic data to calculate the indication of relative temporal proximity.

The traffic data may be used to calculate the associated first temporal proximity relating to the calculated first optimum route.

The processing resource may be arranged to use the traffic data to calculate the first optimum route.

The traffic data may be used to calculate the associated second temporal proximity relating to the calculated second optimum route.

The processing resource may be arranged to use the traffic data to calculate the second optimum route.

The processing resource may be arranged to access calculated road speed data and to use the calculated road speed data to calculate the indication of relative temporal proximity.

The calculated road speed data may be based upon traffic speed measurements. The calculated road speed data may be based upon empirical data as opposed to legal road speed limit data. The calculated road speed data may be capped by respective legal road speed limit data. The processing resource may be arranged to use the calculated road speed data to calculate the associated first temporal proximity data relating to the calculated first optimum route. Additionally or alternatively, the processing resource may be arranged to use the calculated road speed data to calculate the associated second temporal proximity data relating to the calculated second optimum route.

According to a third aspect of the present invention, there is provided a navigation system comprising: the navigation apparatus as set forth above in relation to the first aspect of the invention; and the server apparatus as set forth above in relation to the second aspect of the invention; wherein the message and the point of interest data are communicated over the communications network.

The communications network may be a wireless communications network.

According to a fourth aspect of the present invention, there is provided a method of providing point of interest information, the method comprising: a navigation apparatus receiving a request for point of interest information; the navigation apparatus outsourcing the request for point of interest information to a remote server via a communications network; and the navigation apparatus receiving point of interest data identifying a first point of interest and a second point of interest, the point of interest data being in response to the message and arranged to provide an indication of relative temporal proximity of the first and second points of interest.

The method may further comprise: the navigation apparatus responding to the request for point of interest information by identifying the first point of interest and the second point of interest and relative temporal proximity information relating thereto, the relative temporal proximity information being based upon the indication of relative temporal proximity received.

According to a fifth aspect of the present invention, there is provided a method of providing point of interest information, the method comprising: receiving a message constituting a point of interest information request; generating point of interest data in response to the received message so as to identifying a first point of interest and a second point of interest and to provide an indication of relative temporal proximity of the first and second points of interest; communicating the point of interest data for receipt by a navigation apparatus.

The processing resource may be arranged to access a database of points of interest data and determine the first and second points of interest from the database of points of interest data.

According to a sixth aspect of the present invention, there is provided a computer program element comprising computer program code means to make a computer execute the method as set forth above in relation to the fourth or fifth aspects of the invention.

The computer program element may be embodied on a computer readable medium.

According to a seventh aspect of the present invention, there is provided a navigation apparatus comprising: a communications interface for communicating data via a communications network; a processing resource coupled to the communications interface, the processing resource being arranged, when in use, to receive a request for point of interest information; wherein the processing resource is arranged to outsource, when in use, the request for point of interest information to a remote server via the communications network and receive from the remote server point of interest data in reply, the point of interest data identifying a first point of interest and a second point of interest.

Advantages of these embodiments are set out hereafter, and further details and features of each of these embodiments are defined in the accompanying dependent claims and elsewhere in the following detailed description.

It is thus possible to provide a navigation apparatus, a server apparatus and a method therefor capable of providing POI information that is of greater quality than POI information ranked by distance from a current location of the navigation apparatus. Additionally, the POI information is provided without placing additional processing demands on the navigation apparatus, thereby leaving the processing resource of the navigation apparatus free for other processing tasks. POI information of improved accuracy and usefulness is thus provided relatively quickly and faster than if the processing resource of the navigation apparatus were to have performed multiple local temporal proximity calculations. Furthermore, the user of the navigation apparatus can take advantage of optional features available to improve accuracy of calculation of the temporal proximity information. The apparatus and method thus provide an improved user experience in relation to the navigation apparatus, as well as the possibility of saving the user time and inconvenience.

### BRIEF DESCRIPTION OF THE DRAWINGS

At least one embodiment of the invention will now be described, by way of example only, with reference to the accompanying drawings, in which:

FIG. 1 is a schematic illustration of an exemplary part of a Global Positioning System (GPS) usable by a navigation apparatus;

FIG. 2 is a schematic diagram of a communications system for communication between a navigation apparatus and a server apparatus;

FIG. 3 is a schematic illustration of electronic components of the navigation apparatus of FIG. 2 or any other suitable navigation apparatus;

FIG. 4 is a schematic diagram of an arrangement of mounting and/or docking a navigation apparatus;

FIG. 5 is a schematic representation of an architectural stack employed by the navigation apparatus of FIG. 3;

FIG. 6 is a schematic illustration of entities supported by the navigation apparatus of FIG. 3 and constituting another embodiment of the invention; FIG. 7 is a schematic illustration of entities supported by the server apparatus of FIG. 2 and constituting an embodiment of the invention;

FIG. 8 is a flow diagram of a method of providing point of interest information implemented by the entities of FIG. 6;

FIGS. 9 to 17 are screen shots from the navigation apparatus in accordance with a part of the method of FIG. 8;

FIGS. 18 to 22 are screen shots from the navigation apparatus in accordance with other parts of the method of FIG. 8;

FIG. 23 is a flow diagram of a method of providing point of interest information implemented by the entities of FIG. 7; and

FIGS. 24 and 25 are screen shots from the navigation apparatus in accordance with another part of the method of FIG. 8.

### DETAILED DESCRIPTION OF PREFERRED EMBODIMENTS

Throughout the following description identical reference numerals will be used to identify like parts.

Embodiments of the present invention will now be described with particular reference to a PND. It should be remembered, however, that the teachings herein are not limited to PNDs but are instead universally applicable to any type of processing device that is configured to execute navigation software in a portable and/or mobile manner so as to provide route planning and navigation functionality. It follows therefore that in the context of the embodiments set forth herein, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software.

It will also be apparent from the following that the teachings herein even have utility in circumstances, where a user is not seeking instructions on how to navigate from one point to another, but merely wishes to be provided with views of current locations during a journey (“free-driving”). In such circumstances the “destination” location selected by the user need not have a corresponding start location from which the user wishes to start navigating, and as a consequence references herein to the “destination” location or indeed to a “destination” view should not be interpreted to mean that the generation of an initial route is essential, that travelling to the “destination” must occur, or indeed that the presence of a destination requires the designation of a corresponding start location.

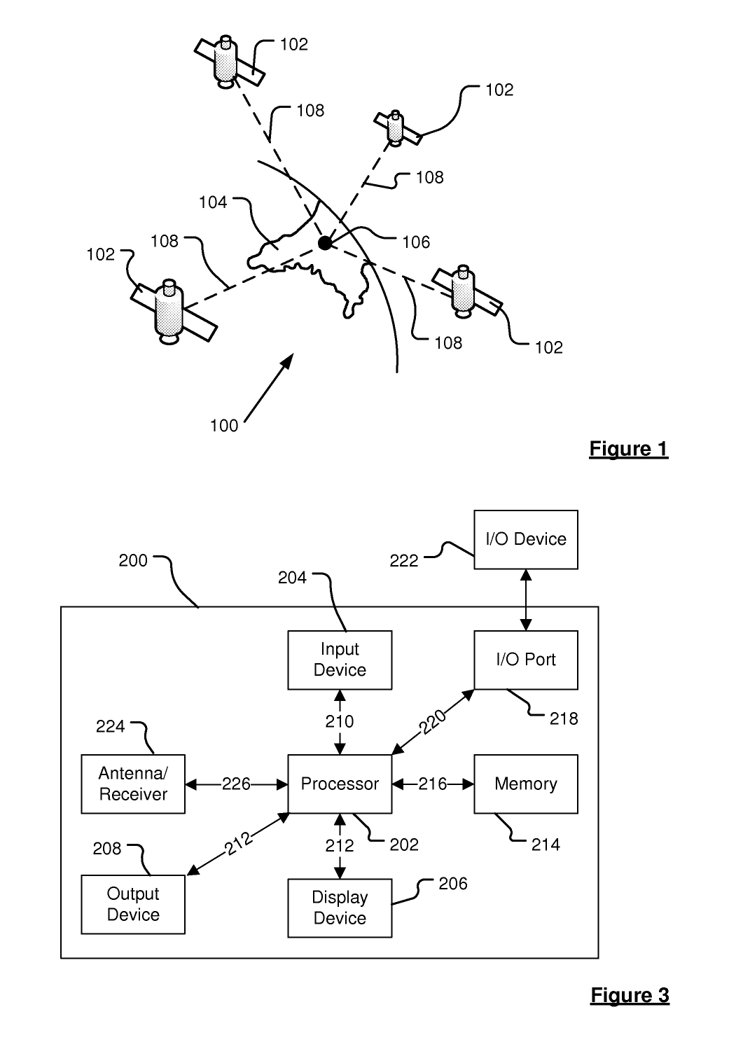

With the above provisos in mind, the Global Positioning System (GPS) of FIG. 1 and the like are used for a variety of purposes. In general, the GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system 100 comprises a plurality of satellites 102 orbiting about the earth 104. A GPS receiver 106 receives spread spectrum GPS satellite data signals 108 from a number of the plurality of satellites 102. The spread spectrum data signals 108 are continuously transmitted from each satellite 102, the spread spectrum data signals 108 transmitted each comprise a data stream including information identifying a particular satellite 102 from which the data stream originates.

The GPS receiver 106 generally requires spread spectrum data signals 108 from at least three satellites 102 in order to be able to calculate a two-dimensional position. Receipt of a fourth spread spectrum data signal enables the GPS receiver 106 to calculate, using a known technique, a three-dimensional position.

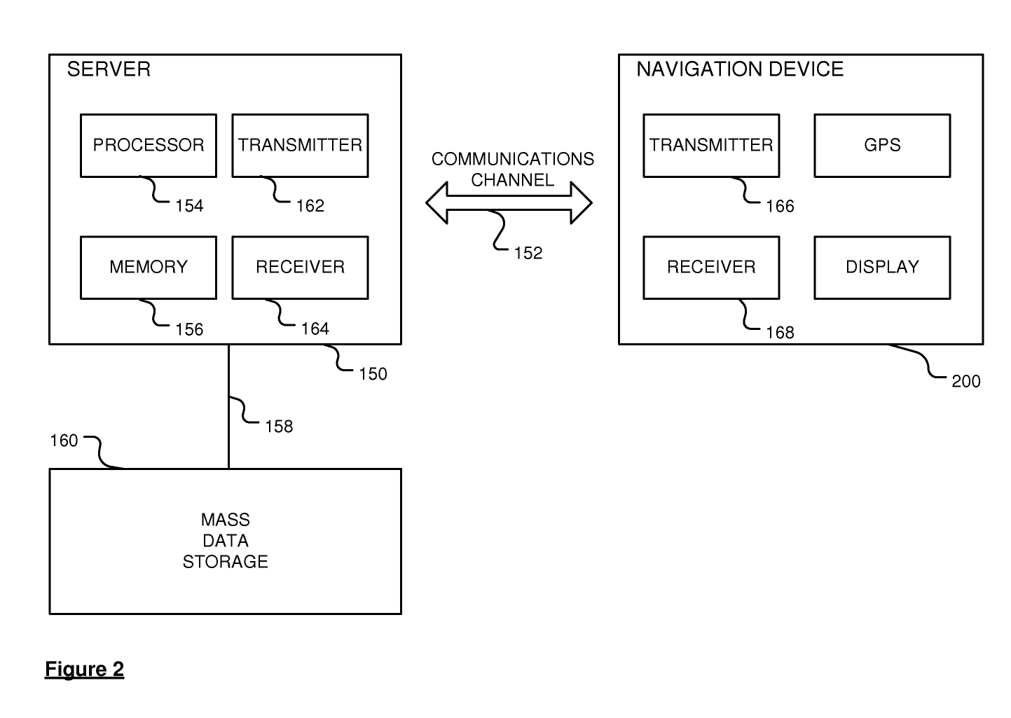

In FIG. 2, a navigation system comprises a navigation apparatus 200 in communication with the server 150 via a communications channel 152 supported by a communications network that can be implemented by any of a number of different arrangements. The communication channel 152 generically represents the propagating medium or path that connects the navigation device 200 and the server 150. The server 150 and the navigation device 200 can communicate when a connection via the communications channel 152 is established between the server 150 and the navigation device 200 (noting that such a connection can be a data connection via mobile device, a direct connection via personal computer via the internet, etc.).

The communication channel 152 is not limited to a particular communication technology. Additionally, the communication channel 152 is not limited to a single communication technology; that is, the channel 152 may include several communication links that use a variety of technology. For example, the communication channel 152 can be adapted to provide a path for electrical, optical, and/or electromagnetic communications, etc. As such, the communication channel 152 includes, but is not limited to, one or a combination of the following: electric circuits, electrical conductors such as wires and coaxial cables, fibre optic cables, converters, radio-frequency (RF) waves, the atmosphere, free space, etc. Furthermore, the communication channel 152 can include intermediate devices such as routers, repeaters, buffers, transmitters, and receivers, for example.

In one illustrative arrangement, the communication channel 152 is supported by telephone and computer networks. Furthermore, the communication channel 152 may be capable of accommodating wireless communication, for example, infrared communications, radio frequency communications, such as microwave frequency communications, etc. Additionally, the communication channel 152 can accommodate satellite communication.

The communication signals transmitted through the communication channel 152 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 152. These signals may be modulated, encrypted and/or compressed signals as may be desirable for the communication technology.

In this example, the navigation device 200 comprising or coupled to the GPS receiver device 106, is capable of establishing a data session, if required, with network hardware of a communications network, for example a “mobile” communications network via a wireless communications terminal (not shown), such as a mobile telephone, PDA, and/or any device with mobile telephone technology, in order to establish a digital connection, for example a digital connection via known Bluetooth technology. Thereafter, through its network service provider, the mobile terminal can establish a network connection (through the Internet for example) with a server 150. As such, a “mobile” network connection can be established between the navigation device 200 (which can be, and often times is, mobile as it travels alone and/or in a vehicle) and the server 150 to provide a “real-time” or at least very “up to date” gateway for information.

In this example, the navigation apparatus 200 is a Bluetooth enabled navigation device in order that the navigation device 200 can be agnostic to the settings of the wireless communications terminal, thereby enabling the navigation apparatus 200 to operate correctly with the ever changing spectrum of mobile telephone models, manufacturers, etc. Model/manufacturer specific settings may, for example, be stored on the navigation device 200. The data stored for this information can be updated.

Although not shown, instead of requiring the wireless communications terminal to provide access to the communications network, the navigation device 200 can, of course, comprise mobile telephone technology, including an antenna, for example, or optionally using an internal antenna of the navigation device 200. The mobile telephone technology within the navigation device 200 can also include an insertable card (e.g. Subscriber Identity Module (SIM) card). As such, mobile telephone technology within the navigation device 200 can similarly establish a network connection between the navigation device 200 and the server 150, via the Internet for example, in a manner similar to that of any wireless communications-enabled terminal.

The establishing of the network connection between the mobile device (via a service provider) and another device such as the server 150, using the Internet for example, can be done in a known manner. In this respect, any number of appropriate data communications protocols can be employed, for example the TCP/IP layered protocol. Furthermore, the mobile device can utilize any number of communication standards such as CDMA2000, GSM, IEEE 802.11 a/b/c/g/n, etc.

Hence, it can be seen that the internet connection may be utilised, which can be achieved via a data connection using the mobile telephone or mobile telephone technology.

The server 150 includes, in addition to other components which may not be illustrated, a processor 154 operatively connected to a memory 156 and further operatively connected, via a wired or wireless connection 158, to a mass data storage device 160. The mass storage device 160 contains a store of navigation data and map information, and can again be a separate device from the server 150 or can be incorporated into the server 150. The processor 154 is further operatively connected to transmitter 162 and receiver 164, to transmit and receive information to and from navigation device 200 via the communications channel 152. The signals sent and received may include data, communication, and/or other propagated signals. The transmitter 162 and receiver 164 may be selected or designed according to the communications requirement and communication technology used in the communication design for the navigation system 200. Further, it should be noted that the functions of transmitter 162 and receiver 164 may be combined into a single transceiver.

As mentioned above, the navigation device 200 can be arranged to communicate with the server 150 through communications channel 152, using transmitter 166 and receiver 168 to send and receive signals and/or data through the communications channel 152, noting that these devices can further be used to communicate with devices other than the server 150. Further, the transmitter 166 and receiver 168 are selected or designed according to communication requirements and communication technology used in the communication design for the navigation device 200 and the functions of the transmitter 166 and receiver 168 may be combined into a single transceiver as described above in relation to FIG. 2. Of course, the navigation device 200 comprises other hardware and/or functional parts, which will be described later herein in further detail.

Software stored in server memory 156 provides instructions for the processor 154 and allows the server 150 to provide services to the navigation device 200. One service provided by the server 150 involves processing requests from the navigation device 200 and transmitting navigation data from the mass data storage 160 to the navigation device 200. Another service that can be provided by the server 150 includes processing the navigation data using various algorithms for a desired application and sending the results of these calculations to the navigation device 200.

The server 150 constitutes a remote source of data accessible by the navigation device 200 via, for example, a wireless channel. The server 150 may include a network server located on a local area network (LAN), wide area network (WAN), virtual private network (VPN), etc.

The server 150 may include a personal computer such as a desktop or laptop computer, and the communication channel 152 may be a cable connected between the personal computer and the navigation device 200. Alternatively, a personal computer may be connected between the navigation device 200 and the server 150 to establish an internet connection between the server 150 and the navigation device 200.

The navigation device 200 may be provided with information from the server 150 via information downloads which may be periodically updated automatically or upon a user connecting the navigation device 200 to the server 150 and/or may be more dynamic upon a more constant or frequent connection being made between the server 150 and navigation device 200 via a wireless mobile connection device and TCP/IP connection for example. For many dynamic calculations, the processor 154 in the server 150 may be used to handle the bulk of processing needs, however, a processor (not shown in FIG. 2) of the navigation device 200 can also handle much processing and calculation, oftentimes independent of a connection to a server 150.

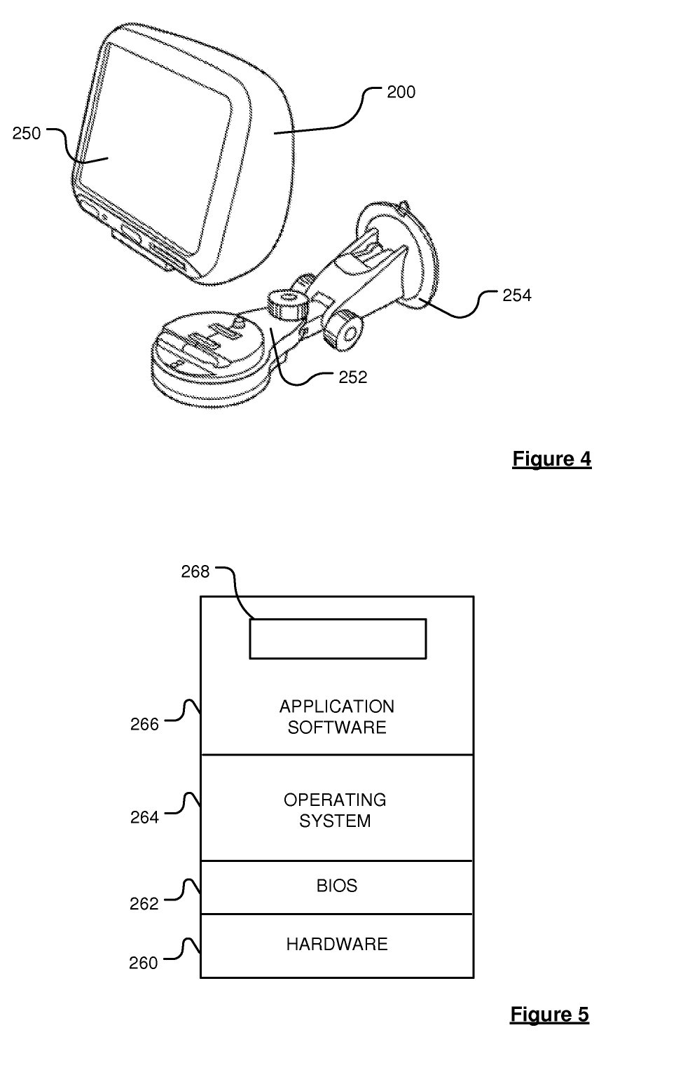

Referring to FIG. 3, it should be noted that the block diagram of the navigation device 200 is not inclusive of all components of the navigation device, but is only representative of many example components. The navigation device 200 is located within a housing (not shown). The navigation device 200 includes a processing resource comprising, for example, the processor 202 mentioned above, the processor 202 being coupled to an input device 204 and a display device, for example a display screen 206. Although reference is made here to the input device 204 in the singular, the skilled person should appreciate that the input device 204 represents any number of input devices, including a keyboard device, voice input device, touch panel and/or any other known input device utilised to input information. Likewise, the display screen 206 can include any type of display screen such as a Liquid Crystal Display (LCD), for example.

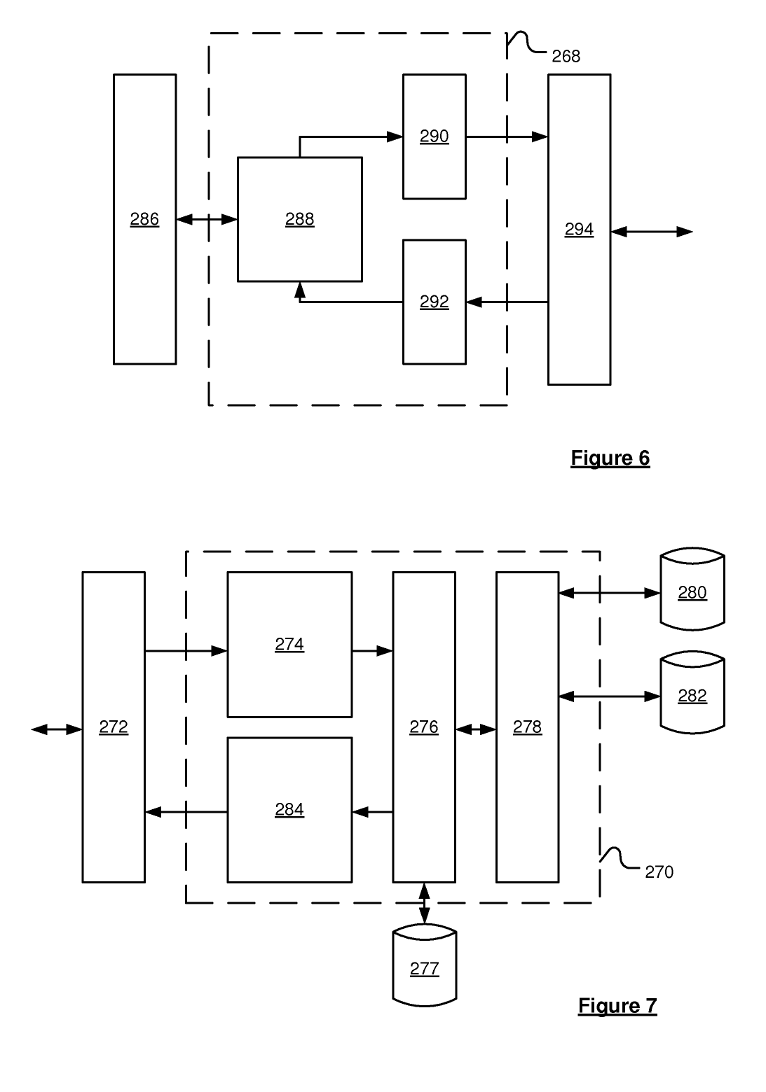

In one arrangement, one aspect of the input device 204, the touch panel, and the display screen 206 are integrated so as to provide an integrated input and display device, including a touchpad or touchscreen input 250 (FIG. 4) to enable both input of information (via direct input, menu selection, etc.) and display of information through the touch panel screen so that a user need only touch a portion of the display screen 206 to select one of a plurality of display choices or to activate one of a plurality of virtual or “soft” buttons. In this respect, the processor 202 supports a Graphical User Interface (GUI) that operates in conjunction with the touchscreen.

In the navigation device 200, the processor 202 is operatively connected to and capable of receiving input information from input device 204 via a connection 210, and operatively connected to at least one of the display screen 206 and the output device 208, via respective output connections 212, to output information thereto. The navigation device 200 may include an output device 208, for example an audible output device (e.g. a loudspeaker). As the output device 208 can produce audible information for a user of the navigation device 200, it is should equally be understood that input device 204 can include a microphone and software for receiving input voice commands as well. Further, the navigation device 200 can also include any additional input device 204 and/or any additional output device, such as audio input/output devices for example. The processor 202 is operatively connected to memory 214 via connection 216 and is further adapted to receive/send information from/to input/output (I/O) ports 218 via connection 220, wherein the I/O port 218 is connectible to an I/O device 222 external to the navigation device 200. The external I/O device 222 may include, but is not limited to an external listening device, such as an earpiece for example. The connection to I/O device 222 can further be a wired or wireless connection to any other external device such as a car stereo unit for hands-free operation and/or for voice activated operation for example, for connection to an earpiece or headphones, and/or for connection to a mobile telephone for example, wherein the mobile telephone connection can be used to establish the data connection between the navigation device 200 and the server 150 via the Internet or any other network for example.

FIG. 3 further illustrates an operative connection between the processor 202 and an antenna/receiver 224 via connection 226, wherein the antenna/receiver 224 can be a GPS antenna/receiver for example. It should be understood that the antenna and receiver designated by reference numeral 224 are combined schematically for illustration, but that the antenna and receiver may be separately located components, and that the antenna may be a GPS patch antenna or helical antenna for example.

It will, of course, be understood by one of ordinary skill in the art that the electronic components shown in FIG. 3 are powered by one or more power sources (not shown) in a conventional manner. As will be understood by one of ordinary skill in the art, different configurations of the components shown in FIG. 3 are contemplated. For example, the components shown in FIG. 3 may be in communication with one another via wired and/or wireless connections and the like. Thus, the navigation device 200 described herein can be a portable or handheld navigation device 200.

In addition, the portable or handheld navigation device 200 of FIG. 3 can be connected or “docked” in a known manner to a vehicle such as a bicycle, a motorbike, a car or a boat for example. Such a navigation device 200 is then removable from the docked location for portable or handheld navigation use.

Referring to FIG. 4, the navigation device 200 may be a unit that includes the integrated input and display device 206 and the other components of FIG. 2 (including, but not limited to, the internal GPS receiver 224, the microprocessor 202, a power supply (not shown), memory systems 214, etc.).

The navigation device 200 may sit on an arm 252, which itself may be secured to a vehicle dashboard/window/etc. using a suction cup 254. This arm 252 is one example of a docking station to which the navigation device 200 can be docked. The navigation device 200 can be docked or otherwise connected to the arm 252 of the docking station by snap connecting the navigation device 200 to the arm 252 for example. The navigation device 200 may then be rotatable on the arm 252. To release the connection between the navigation device 200 and the docking station, a button (not shown) on the navigation device 200 may be pressed, for example. Other equally suitable arrangements for coupling and decoupling the navigation device 200 to a docking station are well known to persons of ordinary skill in the art.

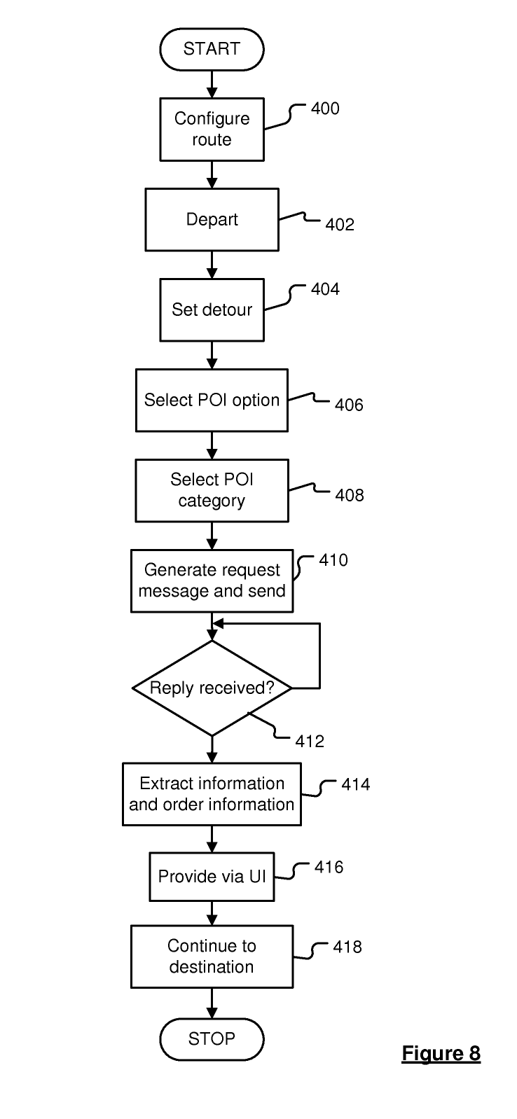

Turning to FIG. 5, the processor 202 and memory 214 cooperate to support a BIOS (Basic Input/Output System) 262 that functions as an interface between functional hardware components 260 of the navigation device 200 and the software executed by the device. The processor 202 then loads an operating system 264 from the memory 214, which provides an environment in which application software 266 (implementing some or all of the above described route planning and navigation functionality) can run. The application software 266 provides an operational environment including the GUI that supports core functions of the navigation device 200, for example map viewing, route planning, navigation functions and any other functions associated therewith. In this respect, part of the application software 266 comprises a POI information entity 268.

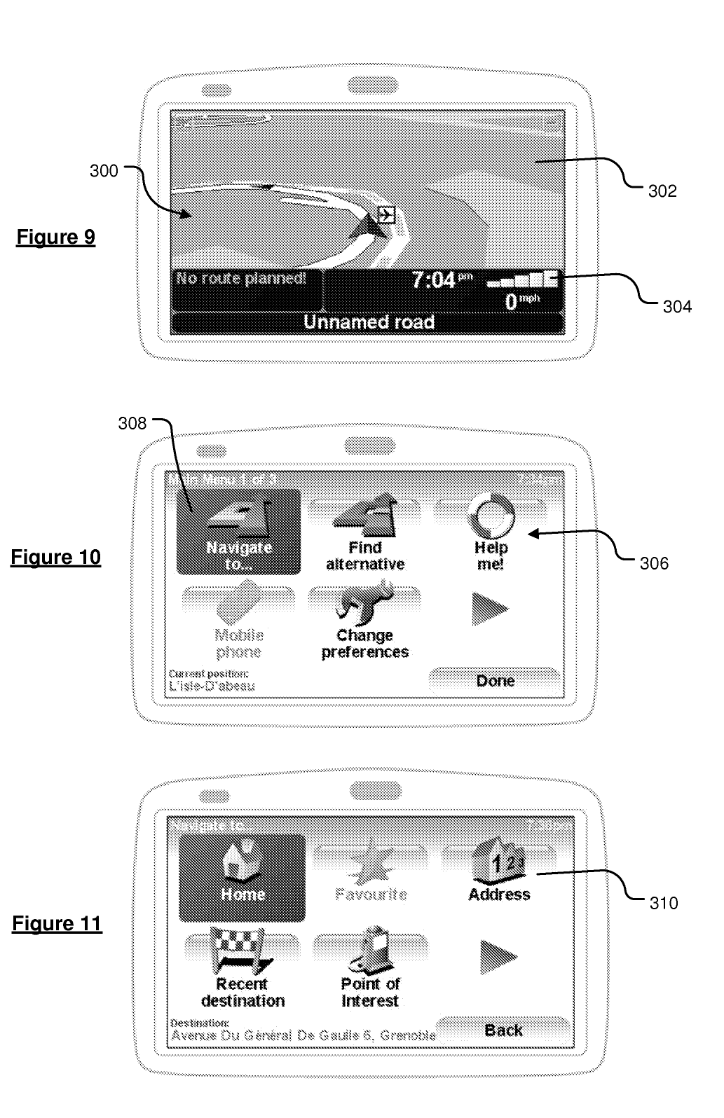

Turning to FIG. 6, the POI information entity 268 is capable of communicating with a user interface module 286 of the navigation apparatus 200, in particular, a POI information request processor 288 of the POI information entity 268. The POI request processor 288 is coupled to a POI message generator 290 and a POI data message processor 292. The POI message generator 290 and the POI data message processor 292 are capable of communicating with a first communications interface 294, the second communications interface 294 being operably coupled to the I/O port 218 for communicating over the communications channel 152.

Referring to FIG. 7, the processing resource 154 of the server apparatus 150 supports a POI request server entity 270 that is operably coupled to a second communications interface 272 of the server 150 for communicating over the communications channel 152. The POI request server entity 270 comprises a POI message parser 274 capable of communicating with a POI data generator 276. The POI data generator 276 is capable of accessing a database of POI data 277 and communicating with a route calculator 278 that has access to a database of traffic data 280 and a database of calculated road speeds 282. The POI data generator 276 is also capable of communicating with a POI data reply generator 284 that is capable of communicating with the second communications interface 272. The database of POI data 277 contains identities of locations tagged by POI category and longitude and latitude coordinates.

Operation of the above navigation apparatus 200 and the server apparatus 150 will now be described in the context of a user of the navigation apparatus 200 wishing to travel between two locations in France. However, the skilled person should appreciate that other equally applicable examples are conceivable and the choice of locations is not intended to be limiting.

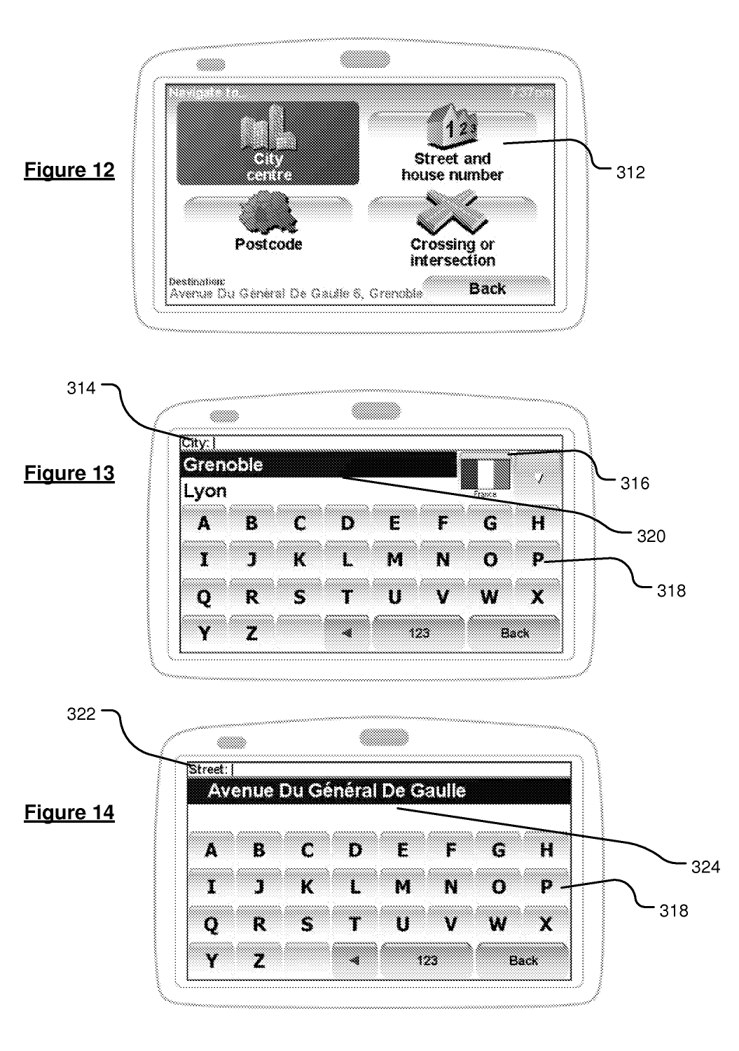

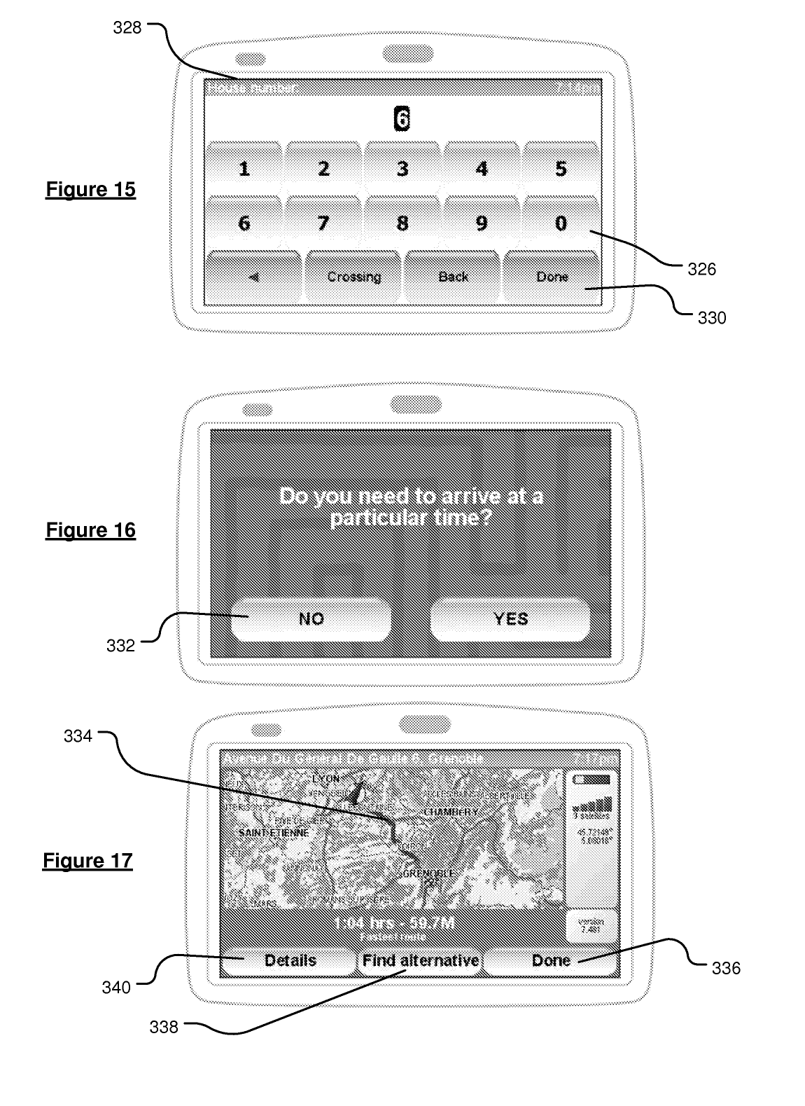

In operation (FIG. 8), the user located at an airport in Lyon, France requires navigation assistance to a street address in Grenoble, France for which the user knows the street name and building number. The user therefore configures (Step 400) a route as follows. Referring to FIGS. 9 to 17, the user undertakes an illustrative destination location input process described hereinbelow. Although not shown, the user uses a settings menu option supported by the application software 266 in order to select view generation in a three-dimensional mode.

When the user switches on the navigation device 200, the device 200 acquires a GPS fix and performs a self-location determination by calculating (in a known manner) the current location of the navigation device 200. The user is then presented, as shown in FIG. 9, with a display 300 showing in pseudo three-dimensions the local environment 302 in which the navigation device 200 is determined to be located and, in a region 304 of the display 300 below the local environment, a series of control and status messages.

By touching the display of the local environment 302, the navigation device 200 updates the display 300 by displaying (as shown in FIG. 10) a series of virtual or soft buttons 306 by means of which the user can, inter alia, input a destination to which the user wishes to navigate.

By touching the “Navigate to” virtual button 308, the navigation device 200 switches to display (as shown in FIG. 11) a plurality of virtual buttons that are each associated with a different category of selectable destinations. In this instance, the display shows a “Home” button that if pressed would set the destination to a stored home location. A “Favourite” soft button, if pressed, reveals a list of destinations that the user has previously stored in the navigation device 200 and if one of these destinations is then selected the destination for the route to be calculated is set to the selected previously stored destination. A “Recent destination” soft button, if pressed, reveals a list of selectable destinations held in the memory of the navigation device 200 and to which the user has recently navigated. Selection of one of the destinations populating this list would set the destination location for this route to the selected (previously visited) location. The “Point of interest” button, if pressed, reveals a number of options by means of which a user can opt to navigate to any of a plurality of locations, such as Automatic Teller Machines (ATMs), petrol stations or tourist attractions for example, which have been pre-stored in the navigation device 200 as locations to which a user of the navigation device 200 might want to navigate to. The triangular “arrow” shaped virtual button provides access to additional sub-menu options relating to the “Navigate to . . . ” menu option, and an “Address” button 310 commences a process by which the user can input the street address of the destination to which the user wishes to navigate.

Since the user, in this example, knows the street address of the destination to which the user wishes the navigation device 200 to navigate, it is assumed that the “address” button 310 is operated (by touching the button displayed on the touchscreen), whereupon (as shown in FIG. 12) the user is presented with a series of address input options—in particular for address input by “city centre”, by “postcode”, by “crossing or intersection” (for example a junction of two roads) and by “street and house number”.

In this example, the user knows the street address and house number of the destination and hence selects a “street and house number” virtual button 312 whereupon the user is then presented, as shown in FIG. 13, with a prompt 314 to enter the name of the city to which they wish to navigate, a flag button 316 by means of which the user can select the country in which the desired city is located, and a virtual keyboard 318 that may be operated by the user, if necessary, to input the name of the destination city. In this instance the user has previously navigated to locations in Lyon and Grenoble, and the navigation device 200 therefore additionally provides the user with a list 320 of selectable cites.

The user in this instance wishes to navigate to Grenoble, and on selection of Grenoble from the list 320 the navigation device 200 displays, as shown in FIG. 14, the virtual keyboard 318 by means of which a user can input street names, a prompt 322 for entry of a street name and, in this instance, as the user has previously navigated to a street in Grenoble, a list 324 of selectable streets in Grenoble.

In this example, the user wishes to return to the street, Avenue Du Général De Gaulle, previously visited by the user and so the user selects Avenue Du Général De Gaulle from the displayed list 324.

Once a street has been selected, the navigation device 200 then displays a restricted, largely numeric, virtual keypad 326 and prompts the user, by means of prompt 328, to enter the number of the house in the selected street and city to which the user wishes to navigate. If the user has previously navigated to a building number in this street, then that number (as shown in FIG. 15) is initially shown. If, as in this instance, the user wishes to navigate to No. 6, Avenue Du Général De Gaulle once again, then the user need only touch a “done” virtual button 330 displayed at the bottom right hand corner of the display 300. If the user should wish to navigate to a different building number in Avenue Du Général De Gaulle, then all the user need do is operate the virtual keypad 326 to input an appropriate building number.

Once the building number has been input or selected, the user is asked, in FIG. 16, whether a particular arrival time is required. If the user should push the “Yes” button, then functionality is invoked that estimates the time required to travel to the destination and advises the user when they should leave (or if they are running late, should have left) their current location in order to arrive at their destination on time. In this instance, the user is not concerned about arriving at a particular time and hence selects the “No” virtual button 322.

Selecting the “No” virtual button 332 causes the navigation device 200 to calculate a route between the current location and the selected destination and to display that route 334, as shown in FIG. 17, on a relatively low magnification map that shows the entire route. The user is also provided with: a “Done” virtual button 336 that the user can press to indicate the calculated route is acceptable, a “Find alternative” button 338 that the user can press to cause the navigation device 200 to calculate another route to the selected destination, and a “Details” button 340 that a user can press to reveal selectable options for the display of more detailed information concerning the currently displayed route 334.

In this instance, it is assumed that the user considers the displayed route acceptable, and once the “Done” virtual button 336 has been pressed, the user is presented with a three-dimensional view (not shown) of the current, start, location for the navigation device 200.

Once the destination has been set by the user, the user departs (Step 402) from the starting location and the navigation device 200 guides the user, in a known manner, by updating the map in accordance with determined changes in location of the navigation device 200, and by providing the user with visual and, optionally, audible navigation instructions. In this respect, the navigation apparatus 200, via the processor 202 and the GPS receiver 224 constituting a location determination unit, monitors the location of the navigation device 200. Once the navigation device 200 has progressed a sufficient distance along the route planned by the application software 286 of the navigation device 200, it is necessary to update a three-dimensional view displayed by the display device 206. Using longitude and latitude data relating to the location of the navigation device 200, the application software 286 accesses map data and retrieves terrain data, land use data and road data and renders a three-dimensional view using this information. As the details of rendering views is not central to the description of the embodiments herein, for the sake of clarity and conciseness of description further details of the rendering of views will not be described herein.

In this example, whilst en-route to the destination address, the user discovers that a vehicle in which the user and navigation device 200 are located is running low on fuel and it is necessary to make as quick as possible detour to a petrol station in order to refuel the vehicle. The user therefore has to interact with the user interface of the navigation apparatus 200 in order to set a detour to a petrol station. Consequently, the user has to request POI information from the navigation apparatus 200. Unfortunately, due to the occurrence of a road traffic accident on nearby roads, the closest petrol station to the current location of the vehicle in terms of distance alone is not the petrol station that can be reached quickest. The detour is set as follows.

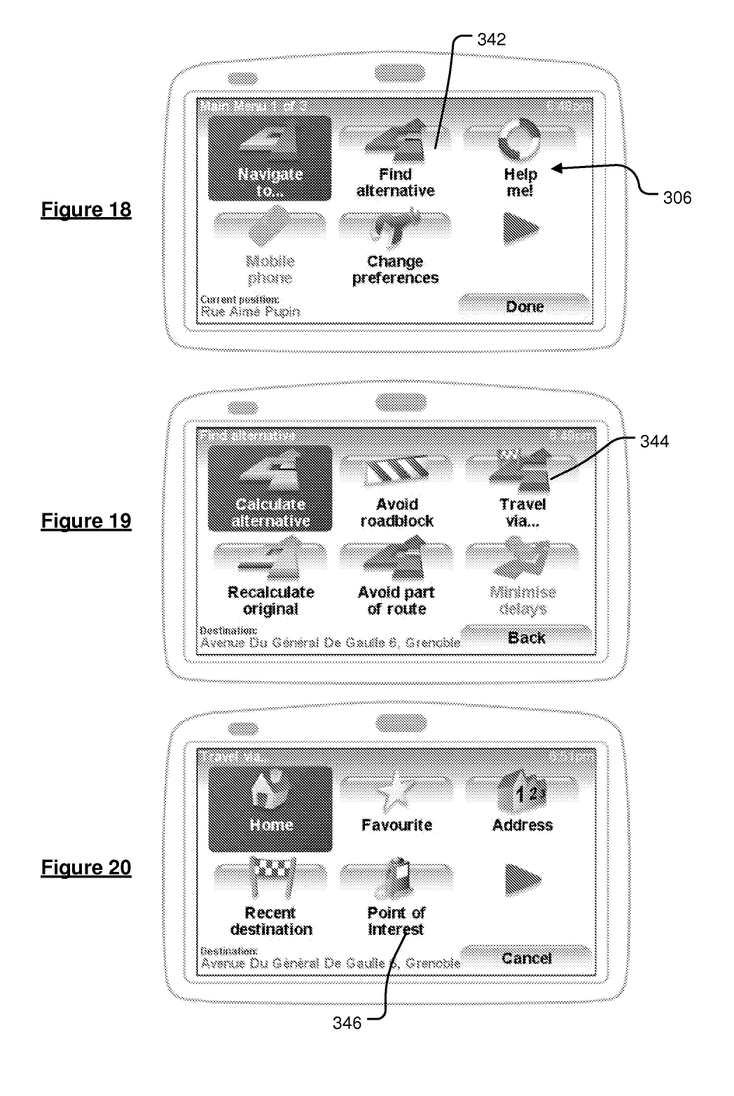

By touching of the portion of the display 300 showing the local environment 302 (FIG. 9), the navigation device 200 updates the display 300 to show (as shown in FIG. 18) again the series of virtual or soft buttons 306 already described above by means of which the user can initiate a detour via a petrol station, the petrol station constituting a POI.

By touching the “Find alternative” virtual button 342 (Step 404), the navigation device 200 switches to display (as shown in FIG. 19) a plurality of virtual buttons associated with recalculation of the current route being implemented by the navigation device. In this example, the display shows a “Calculate alternative” virtual button, an “Avoid roadblock” virtual button, a “Travel via . . . ” virtual button 344, a “Recalculate original” virtual button, an “Avoid part of route” virtual button, and (depending upon available options) a “Minimise delays” virtual button.

In order to initiate the detour mentioned above, the user touches the “Travel via . . . ” button 344 and, in response, the navigation device 200 updates the display 300 to show (as shown in FIG. 20) a plurality of virtual buttons that are each associated with a different category of intermediate point that can form part of a detour. In this instance, the display shows the “Home” virtual button that if pressed would set the intermediate point to a stored home location. The “Favourite” virtual button, if pressed, reveals a list of destinations that the user has previously stored in the navigation device 200 and if one of these destinations is then selected the intermediate point of the detour is set to one of the previously stored destinations. The “Address” soft button commences a process by which the user can input the street address of a location via which the route must pass. The “Recent destination” soft button, if pressed, reveals a list of selectable destinations held in the memory of the navigation device 200 and to which the user has recently navigated. Selection of one of the destinations populating this list would set the current route to pass by the selected (previously visited) location. The “Point of interest” button 346, if pressed, reveals a number of options by means of which the user can opt to navigate to any of a plurality of locations, such as Automatic Teller Machines (ATMs), petrol stations or tourist attractions to which the user of the navigation device 200, for example, might want to navigate to. The triangular “arrowhead” shaped virtual button provides access to additional sub-menu options relating to the “Navigate to . . . ” menu option.

In this example, the user selects (Step 406) the “Points of Interest” soft button 346, in response to which the navigation device 200 updates the display 300 to show (as shown in FIG. 21) a plurality of virtual buttons that are each associated with different location criteria associated with selection of a point of interest, for example: a “POI near you” virtual button 348, a “POI in city” virtual button, a “POI near Home” virtual button, a “POI along route” virtual button, a “POI near destination” virtual button, and a recent popular POI (in this example, “London stansted airport”) virtual button. In order to execute efficiently the task of finding a petrol station as quickly as possible, the user presses the “POI near you” button 348, resulting in the navigation device 200 updating the display 300 again to show a number of POI category options (FIG. 22). In this example, the display shows an “Any POI category” virtual button, selection of which allows a user to select a particular POI by name as opposed to category by textual input, an “Airport” POI selection virtual button, a “Petrol Station” selection virtual button 350, a “Restaurant” selection virtual button, a “Hotel/motel” selection virtual button, and a triangular “arrowhead” shaped virtual button selection of which allows the user to select a particular POI category by textual input. In this example, the user selects (Step 408) the “Petrol Station” virtual button 350.

Once the category of POI has been selected, in this example, petrol stations, the POI request processor 288 obtains the current location of the navigation device 200 and passes current location information and the identified POI category selected to the POI message generator 290, the POI message generator 290 generating (Step 410) a message constituting a request for POI data, the POI message including identifying information, for example message type, such as POI_data_request, the current location information and the POI category required. After establishment of a communications session with the server apparatus 150, the POI message is sent via the first communications interface 294 to the server apparatus 150 via the communications channel 152 using any suitable messaging protocols. Hence, the request from the user for POI information is outsourced to the remote server.

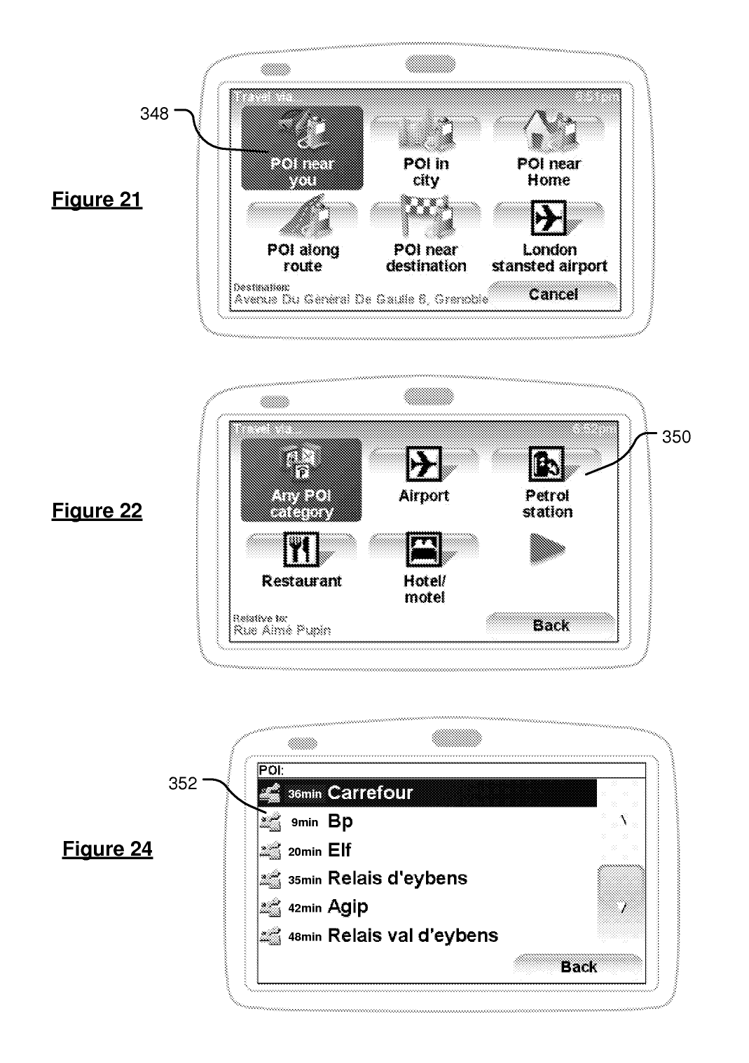

Thereafter (FIG. 23), the server apparatus 150, awaiting receipt (Step 430) of the POI message, receives the POI message via the second communications interface 272 and passes the message to the message parser 274 that identifies the message as a POI request message and extracts (Step 432) the current location information and the POI category selected by the user. The extracted information is passed to the POI data generator 276. The POI data generator 276 then interrogates the database of POI data 277 in order to identify POIs of the type selected that are within a predetermined geographical radius of the current location of the navigation device 200 as identified by the current location information, for example a radius of 50 km.

Once a list of POIs identifying a number of POIs has been generated by the POI data generator 276, in this example a list of petrol stations that are close, in terms of distance, to the current location of the navigation device 200, the POI generator 276 makes respective requests (Step 434) to the route calculator 278 for each POI in the list generated in order to execute optimum route calculations in respect of each POI in the list. The route calculator 278 then calculates respective optimum routes from the current location of the navigation device 200 to each POI in the list respectively. In this example, the optimum route is the temporally shortest, or quickest, route. In order to calculate the optimum routes, the route calculator uses up-to-date traffic information contained in the database of traffic data 280 and actual road speeds attainable for the current time of day from the database of road speed data 282.

The database of road speed data is, in this example, calculated based upon traffic speed measurements for roads, for example at different times of day and/or night. Hence, the road speed data is empirical as opposed to legal road speed limits (the use of the term “road” herein including references to motorways). However, the road speed data can be capped by legal speed limits.

Availability of either or both of these databases for use in determining the points of interest can be dependent upon a subscription of the user, i.e. it may be necessary to have a subscription to enjoy an enhanced degree of accuracy provided through use of one or both of the databases 280, 282 (or any other databases available). In this example, the POI data generator 276 is able to request that the route calculator 278 calculates (Step 436) respective temporal proximity data associated with each optimum route calculated and only return the temporal proximity data calculated, for example arrival times or journey times, the time of course being estimated in this example.

With the temporal proximity data obtained from the route calculator 278, the POI data generator 276 is able to enrich the list of POI data mined from the database of POI data 277 in a number of ways. Firstly, the list of POIs can be supplemented with respective temporal proximity data, for example the estimated arrival times and/or journey times. Additionally or alternatively, the list of POIs can be ordered by shortest temporal proximity to the current location of the navigation device 200 as another way of providing an indication of relative temporal proximity of the number of POIs, for example a first POI and a second POI.

The enriched list of POIs is then passed to the POI data reply generator 284, which generates (Step 438) a reply message containing the enriched list of POI data, the order of the list being retained where appropriate. The POI data reply generator 284 then sends the reply message via the second communications interface 272 to the navigation apparatus 200 via the communications channel 152 supported by the communications network.

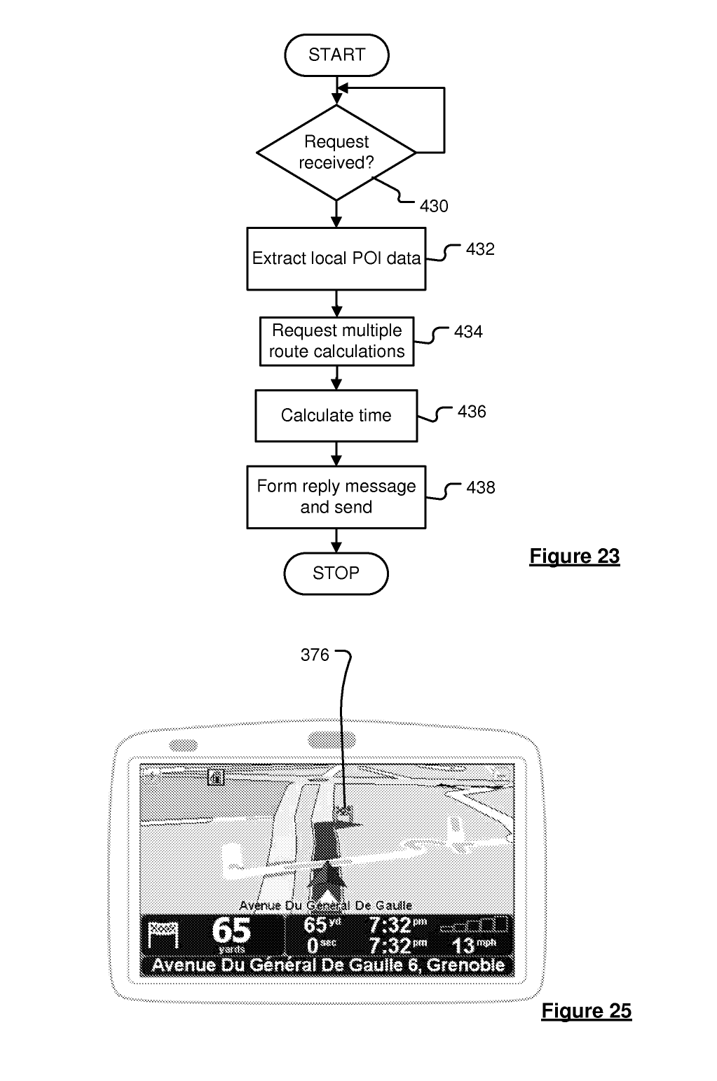

Returning to FIG. 8, the POI data message processor 292 is awaiting (Step 412) reply messages from the server apparatus 150. Upon receipt of the reply message via the first communications interface 294, the data message processor 292 identifies the reply message as relating to a POI information request and extracts (Step 414) the list of POIs and the indication of temporal proximity from the reply message and passes the extracted information to the POI request processor 288. The POI request processor 288 then, if necessary, orders the list of POIs by temporal proximity, the shortest times featuring highest in the list and then the POI request processor 288 provides (Step 416) the list of POIs, in this example, via the user interface 286 for display on the touchscreen 250/display 300 (FIG. 24). Hence, the number of POIs and relative temporal proximity information are identified, in this example, to the user. In this example, the ordering of the list of POIs is not necessary as this implementation shows the POIs ordered by distance from the current location of navigation apparatus 200 as opposed to by temporal proximity. However, the relative temporal proximity information is still provided as each POI displayed is tagged with an associated temporal proximity to the current location of navigation apparatus 200. Consequently, it is possible to communicate to the user the notion of a physically closest POI not being the quickest to reach.

The user can then select one of the POIs presented, in this example the second entry (and temporally closest) in the list of petrol stations displayed 352, and then the application software 266 of the navigation device 200 recalculates the route presently being followed by the user and, after requesting confirmation from the user of the acceptability of the recalculated route (not shown), the user is directed (Step 418) to the petrol station selected as a detour before the user continues from the POI to the destination previously selected.

Referring to FIG. 25, assuming the user follows the instructions provided by the navigation device 200, the navigation device 200 eventually displays a schematic representation of the destination (in this instance: 6 Avenue Du Général De Gaulle) and a chequered flag 376.

It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the above embodiments have been described in the context of a detour from an existing route, the selection and/or determination of POIs described above can be performed whilst navigation is not taking place, for example whilst the user is driving but not taking advantage of the navigation functionality of the navigation apparatus 200, for example when engaging in so-called “free driving”.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A navigation apparatus comprising:
a communications interface for communicating data via a communications network;
a processing resource coupled to the communications interface, the processing resource being arranged, when in use, to receive a request for point of interest information, and to communicate via the communications interface a message constituting a point of interest data request for receipt by a remote server; wherein
the processing resource is capable of receiving via the communications interface point of interest data identifying a first point of interest and a second point of interest, the point of interest data being in response to the message and arranged to provide an indication of relative temporal proximity of the first and second points of interest; and
the processing resource is arranged to respond to the request for point of interest information by identifying the first point of interest and the second point of interest and relative temporal proximity information relating thereto, the relative temporal proximity information being based upon the indication of relative temporal proximity received.

2. An apparatus as claimed in claim 1, wherein the processing resource is arranged to determine self-location information and the indication of relative temporal proximity is with respect to a location associated with the self-location information.

3. An apparatus as claimed in claim 1, wherein the point of interest data received is ordered by relative temporal proximity.

4. An apparatus as claimed in claim 1, wherein the point of interest data comprises respective temporal data for each of the first and second points of interest.

5. An apparatus as claimed in claim 1, wherein the indication of relative temporal proximity is time data.

6. An apparatus as claimed in claim 1, wherein the indication of relative temporal proximity is time of arrival data.

7. An apparatus as claimed in claim 1, wherein the indication of relative temporal proximity is journey time data.

8. An apparatus as claimed in claim 1, wherein the indication of relative temporal proximity is estimated.

9. An apparatus as claimed in claim 1, wherein the processing resource is arranged to support a user interface, and to receive the request for point of interest information via the user interface.

10. A server apparatus comprising:
a communications interface for communicating data via a communications network; and
a processing resource coupled to the communications interface, the processing resource being arranged, when in use, to receive via the communications interface a message constituting a point of interest data request; wherein
the processing resource is arranged to generate point of interest data in response to the received message and communicate via the communications interface the point of interest data for receipt by a navigation apparatus, the point of interest data identifying a first point of interest and a second point of interest; and
the point of interest data is arranged to provide an indication of relative temporal proximity of the first and second points of interest.

11. An apparatus as claimed in claim 10, wherein the processing resource is arranged to receive location information and to calculate a first optimum route from a location identified by the location information received to the first point of interest and an associated first temporal proximity of the location identified to the first point of interest.

12. An apparatus as claimed in claim 10, wherein the processing resource is arranged to receive location information and to calculate a second optimum route from a location identified by the location information received to the second point of interest and an associated second temporal proximity of the location identified to the second point of interest.

13. An apparatus as claimed in claim 11, wherein the processing resource is arranged to access traffic data and to use the traffic data to calculate the indication of relative temporal proximity.

14. An apparatus as claimed in claim 13, wherein the traffic data is used to calculate the associated first temporal proximity relating to the calculated first optimum route.

15. An apparatus as claimed in claim 24, wherein the traffic data is used to calculate the associated second temporal proximity relating to the calculated second optimum route.

16. An apparatus as claimed in claim 10, wherein the processing resource is arranged to access calculated road speed data and to use the calculated road speed data to calculate the indication of relative temporal proximity.

17. A navigation system comprising:
the navigation apparatus as claimed in claim 1; and
the a server apparatus comprising:
a communications interface for communicating data via a communications network; and
a processing resource coupled to the communications interface, the processing resource being arranged, when in use, to receive via the communications interface a message constituting a point of interest data request; wherein
the processing resource is arranged to generate point of interest data in response to the received message and communicate via the communications interface the point of interest data for receipt by a navigation apparatus, the point of interest data identifying a first point of interest and a second point of interest; and
the point of interest data is arranged to provide an indication of relative temporal proximity of the first and second points of interest;
wherein the message and the point of interest data are communicated over the communications network.

18. A method of providing point of interest information, the method comprising:
a navigation apparatus receiving a request for point of interest information;
the navigation apparatus outsourcing the request for point of interest information to a remote server via a communications network; and
the navigation apparatus receiving point of interest data identifying a first point of interest and a second point of interest, the point of interest data being in response to the message and arranged to provide an indication of relative temporal proximity of the first and second points of interest.

19. A method as claimed in claim 18, further comprising:
the navigation apparatus responding to the request for point of interest information by identifying the first point of interest and the second point of interest and relative temporal proximity information relating thereto, the relative temporal proximity information being based upon the indication of relative temporal proximity received.

20. A method of providing point of interest information, the method comprising:
receiving a message constituting a point of interest information request;
generating point of interest data in response to the received message so as to identifying a first point of interest and a second point of interest and to provide an indication of relative temporal proximity of the first and second points of interest; and
communicating the point of interest data for receipt by a navigation apparatus.

21. A computer program element comprising computer program code segments to, when executed, make a computer execute the method as claimed in claim 18.

22. A computer program element as claimed in claim 21, embodied on a non-transitory computer readable medium.

23. A navigation apparatus comprising:
a communications interface for communicating data via a communications network;
a processing resource coupled to the communications interface, the processing resource being arranged, when in use, to receive a request for point of interest information; wherein
the processing resource is arranged to outsource, when in use, the request for point of interest information to a remote server via the communications network and receive from the remote server point of interest data in reply, the point of interest data identifying a first point of interest and a second point of interest.

24. An apparatus as claimed in claim 12, wherein the processing resource is arranged to access traffic data and to use the traffic data to calculate the indication of relative temporal proximity.
